(19) United States
(12) Patent Application Publication
(10) Pub. No.: US 2026/0024245 A1
(43) Pub. Date: Jan. 22, 2026

(54) CUSTOMIZING HAND DRAWN ELECTRONIC TYPOGRAPHY

(71) Applicant: Adobe Inc., San Jose, CA (US)

(72) Inventors: Stuti Jain, Ghaziabad (IN); Praveen Kumar Dhanuka, Howrah (IN); Arushi Jain, Delhi (IN)

(21) Appl. No.: 18/774,141

(22) Filed: Jul. 16, 2024

(51) Int. Cl. G06T 11/20; G06F 40/109

(52) U.S. Cl. CPC G06T 11/203; G06F 40/109; G06T 2200/24

(57) ABSTRACT

This disclosure describes one or more implementations of systems, non-transitory computer-readable media, and methods that enable customization of typography elements through electronic sketching interactions. For instance, the disclosed systems identify, via a user interaction, an electronic sketch interaction on a visual glyph representation. The disclosed systems generate a modified visual glyph representation by modifying one or more curve segments of the visual glyph representation utilizing a sketch outline curve path corresponding to the electronic sketch interaction. Moreover, in some implementations, the disclosed systems utilize the modified visual glyph representation as an additional editable typography element.

### BACKGROUND

Recent years have seen an increase in the utilization of digital typography elements in digital content creation. For example, individuals and businesses increasingly utilize computing devices to create typography elements that visually represent glyphs within digital content. Furthermore, in many instances, conventional typography graphics systems enable users to place typography elements within digital content and to visually modify the displayed typography elements (via image modification tools). Indeed, digital content designers often use conventional systems in an attempt to create and/or customize electronic typography. Although many conventional systems visually modify typography elements, many of these conventional systems have a number of shortcomings, particularly with regards to flexibly and accurately providing tools to visually customize electronic typography.

### SUMMARY

This disclosure describes one or more implementations of systems, non-transitory computer readable media, and computer-implemented methods that solve one or more of the following problems by enabling customization of typography elements through electronic (free form) sketching interactions. In particular, in one or more embodiments, the disclosed systems utilize electronic sketch interactions in relation to a visual representation of a glyph to visually customize the glyph while maintaining typography editability properties of the visually modified glyph. For instance, the disclosed systems identify a glyph outline (e.g., one or more curve segments of a glyph) for a glyph near a detected position of an electronic sketch interaction. Moreover, in one or more implementations, the disclosed systems utilize glyph path snapping to identify a starting point for the electronic sketch interaction on the glyph outline. Furthermore, in one or more instances, the disclosed systems identify, from the electronic sketch interaction, an electronic sketch outline (e.g., a free form sketch outline). In addition, in one or more implementations, the disclosed systems utilize sampling of the glyph outline for the electronic sketch outline to perform over sketching to modify curve segments of the glyph with the sampled sketch outline curve to generate a customized glyph that maintains typography editability properties. Moreover, in one or more embodiments, the disclosed systems also enable re-editing of the customized glyph through subsequent electronic sketch interactions using metadata of the glyph and the sampled sketch outline curve.

### BRIEF DESCRIPTION OF THE DRAWINGS

The detailed description is described with reference to the accompanying drawings in which:

FIG. 1 illustrates a schematic diagram of an example environment in which a digital typography customization system operates in accordance with one or more implementations.

FIG. 2 illustrates an overview of an implementation of the digital typography customization system modifying a glyph using an electronic sketch interaction in accordance with one or more implementations.

FIG. 3 illustrates a digital typography customization system receiving an electronic sketch interaction to customize a glyph and generating a sketch outline in accordance with one or more implementations.

FIG. 4 illustrates a digital typography customization system modifying a visual glyph representation using a sketch outline through over sketching in accordance with one or more implementations.

FIG. 5 illustrates a flow diagram of a digital typography customization system re-editing a modified visual glyph representation from an additional electronic sketch interaction in accordance with one or more implementations.

FIG. 6 illustrates a digital typography customization system re-editing a modified visual glyph representation from an existing sketch outline curve path in accordance with one or more implementations.

FIG. 7 illustrates a digital typography customization system re-editing a modified visual glyph representation from a glyph and an existing sketch outline curve path in accordance with one or more implementations.

FIG. 8 illustrates a digital typography customization system enabling a utilization of a modified visual glyph representation as a typography element in accordance with one or more implementations.

FIGS. 9 and 10 illustrate examples of a digital typography customization system modifying visual glyph representations from user sketch interactions in accordance with one or more implementations.

FIG. 11 illustrates a schematic diagram of a digital typography customization system in accordance with one or more implementations.

FIG. 12 illustrates a flowchart of a series of acts for customizing typography elements through electronic sketching interactions in accordance with one or more implementations.

FIG. 13 illustrates a block diagram of an example computing device in accordance with one or more implementations.

### DETAILED DESCRIPTION

This disclosure describes one or more implementations of a digital typography customization system that enables customization of glyphs through electronic free form sketching interactions while maintaining typography editability properties of the glyphs. For instance, the digital typography customization system utilizes an electronic sketch interaction (e.g., a free form sketch interaction), received via a graphical user interface in relation to a displayed visual glyph representation of a typography element, to determine a sketch outline based on glyph path snapping. Moreover, in one or more implementations, the digital typography customization system samples curve segments from the visual glyph representation (for the sketch outline) to generate a sketch outline curve path. In addition, in one or more embodiments, the digital typography customization system utilizes over sketching to modify the visual glyph representation from the sketch outline curve path (while maintaining typography property editability for the visual glyph representation). Indeed, in one or more instances, the digital typography customization system utilizes the visually customized glyph as an editable typography element. In some instances, the digital typography customization system also enables re-editing of the customized glyph through subsequent electronic sketch interactions.

In one or more embodiments, the digital typography customization system utilizes glyph path snapping to initiate a sketch interaction with a visual glyph representation. For instance, the digital typography customization system identifies a user sketch interaction and utilizes the position of the sketch interaction to determine a nearest glyph. Moreover, in one or more instances, the digital typography customization system determines (or retrieves) an outline (e.g., one or more curve segments) of the detected glyph. In addition, the digital typography customization system utilizes glyph path snapping to determine a sketch starting point on the glyph for the user sketch interaction. Furthermore, in one or more instances, the digital typography customization system receives additional sketch interactions to determine anchor points and an end position of a sketch to determine a sketch outline (for the glyph customization). In some implementations, the digital typography customization system receives an electronic free form sketch in relation to the visual glyph representation.

Upon determining (or identifying) a sketch outline from the user sketch interaction (in relation to the visual glyph representation), the digital typography customization system modifies the visual glyph representation utilizing the sketch outline. In particular, in one or more instances, the digital typography customization system samples one or more curve segments of the visual glyph representation for the sketch outline and utilizes the sampled curve segments to generate a sketch outline curve path (e.g., via flattening of the sampled curve segments). Furthermore, in one or more embodiments, the digital typography customization system utilizes over sketching with the sketch outline curve path and the one or more curve segments of the visual glyph representation to generate a modified visual glyph representation (e.g., reflecting the customization of the sketch outline).

In one or more instances, the digital typography customization system utilizes the modified visual glyph representation as a typography element. For instance, the digital typography customization system enables the utilization of the modified visual glyph representation as a typed element (e.g., a typography element) within a digital content item. Indeed, in one or more instances, the digital typography customization system generates a modified visual glyph representation that maintains text editability such that the modified visual glyph representation is utilized as a typography element with typographic modification properties intact (e.g., font style adjustments, font size adjustments, font weight adjustments, font color adjustments, font effect adjustments).

In addition, in one or more embodiments, the digital typography customization system utilizes glyph metadata indicating the one or more curve segments of the glyph and sketch outline metadata indicating a sketch outline curve path to enable re-editing of a modified visual glyph representation. For instance, the digital typography customization system utilizes various combinations of the glyph metadata and the sketch outline metadata to re-edit a modified visual glyph representation when a subsequent sketch interaction touches the original glyph, touches both the original glyph and the previous sketch outline modifying the original glyph, and/or touches the previous sketch outline modifying the original glyph. Indeed, in one or more instances, the digital typography customization system enables subsequent modifications to a modified glyph via the utilization of various combinations of the glyph metadata and the sketch outline metadata while maintaining text editability of the subsequently (or re-edited) modified glyph.

As mentioned above, many conventional systems suffer from a number of technical deficiencies. In many cases, conventional systems are rigid and restrictive with respect to customizing glyphs for live text edit typography. For instance, many conventional systems fail to facilitate custom changes in glyphs for live text edit typography. Some conventional systems, enable custom changes of glyphs through conversion techniques. In particular, oftentimes, conventional systems convert live edit text glyphs into outlined text and enable the use of sketch interactions (e.g., a pencil tool) to customize the outlined text. However, such conventional system approaches that utilize a text outline conversion are inflexible and restrictive. In particular, oftentimes, conventional systems that convert live edit text glyphs to outlined text to customize the glyphs often destroy the text editability of the live edit text glyphs. Indeed, this often restricts customization and utilization of the text outline based glyph to the particular customized glyph and is often not reusable as a typography element.

Furthermore, some conventional systems enable the creation of an attachment that is attachable to a glyph. Indeed, in some cases, conventional systems enable attachment of a custom design to a glyph via click and drag operations. However, such approaches are often inaccurate and inefficient. For instance, conventional systems that enable attachment via click and drag operations often result in inaccurate attachments that fail to line up with existing glyphs and/or are incompatible by size. This often results in unsmooth customization of glyphs. Furthermore, in many cases, the utilization of attachments to customize glyphs in some conventional systems, often results in inefficient interactions that require multiple iterations to smoothly attach custom designs (e.g., to match sizes, to match shape contours, to match alignment).

Some conventional systems enable users to utilize electronic drawing tools to create digital hand drawn fonts. Nonetheless, these conventional systems are also inflexible and restrictive. Indeed, oftentimes, conventional systems that enable creators to utilize electronic drawing tools to create digital hand drawn fonts are limited to the initial creation of the hand drawn fonts. Such conventional systems fail to enable customization functionalities via sketch interactions for glyphs to downstream users and limit downstream utilization of the hand drawn fonts as non-modifiable typography elements.

The digital typography customization system provides a number of advantages relative to these conventional systems. For instance, the digital typography customization system enables flexible and dynamic customization of glyphs for live text edit typography. Indeed, unlike many conventional systems that utilize conversion techniques to customize glyphs with a loss of editability, the digital typography customization system, in one or more implementations, facilitates free form sketch customizations of glyphs while maintaining text editability of the glyphs. Indeed, in one or more instances, the digital typography customization system utilizes unrestricted, free form sketches to reshape (or modify) glyphs (one or more multiple times) while also enabling the utilization of the modified glyphs as text editable typography elements. For instance, by sampling a glyph outline to generate a sketch outline curve path to over sketch onto the glyph outline to generate modified curves for the glyph, the digital typography customization system modifies the glyph while maintaining the structure of the glyph (and its text editability). Indeed, the digital typography customization system modifies glyphs such that the modified glyph is capable of typography properties, such as, but not limited to, retyping, text size scaling, movement of (or in) text box, and/or other text transformations.

In addition to flexibility, the digital typography customization system also facilitates accurate and smooth customization of glyphs. For instance, in contrast to some existing systems that enable attachment via click and drag operations that often fail to line up with existing glyphs and/or are incompatible by size, the digital typography customization system utilizes free form sketches and glyph path snapping to generate modified glyphs that are smoother and accurately reflect the input modification request by a designer. In one or more instances, the digital typography customization system also enables multiple iterations of customization via sketch interactions (and the re-editing approach described herein) that smoothly modify glyphs (e.g., without incompatible sizing and/or misaligned edges between a glyph and a modification).

Furthermore, the digital typography customization system also facilitates free form sketching in downstream customization of fonts. For instance, unlike many conventional systems that are limited to using sketch interactions in the creation of fonts, the digital typography customization system enables continued utilization of free form sketching to customize fonts (or typography elements) from a library of available fonts. Indeed, in one or more instances, the digital typography customization system facilitates downstream customization of fonts via free form sketch interactions to generate a modified (or customized) set of fonts that are also useable as text editable fonts.

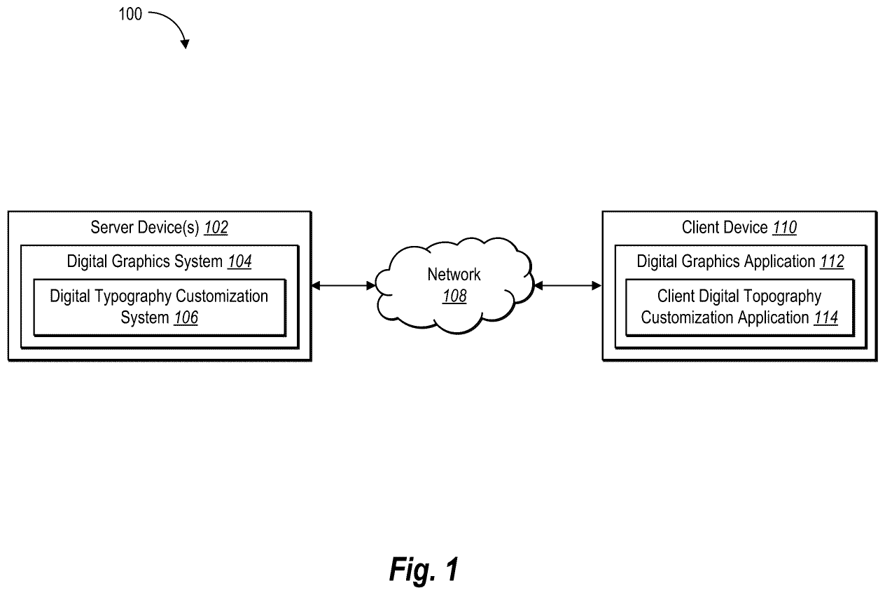

Turning now to the figures, FIG. 1 illustrates a schematic diagram of one or more implementations of a system 100 (or environment) in which a digital typography customization system operates in accordance with one or more implementations. As illustrated in FIG. 1, the system 100 includes a server device(s) 102, a network 108, and a client device 110. As further illustrated in FIG. 1, the server device(s) 102 and the client device 110 communicate via the network 108.

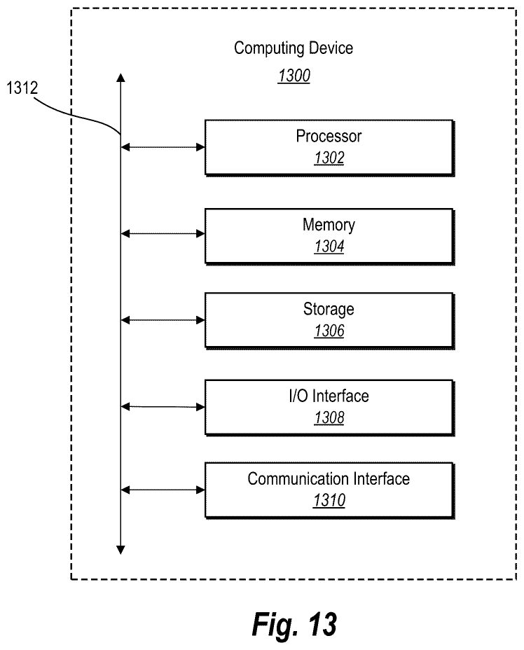

In one or more implementations, the server device(s) 102 includes, but is not limited to, a computing (or computer) device (as explained below with reference to FIG. 13). As shown in FIG. 1, the server device(s) 102 includes a digital graphics system 104 which further includes the digital typography customization system 106. The digital graphics system 104 generates, stores, modifies, and/or utilizes various digital content items, such as, but not limited to, digital images, electronic documents, and/or digital videos. Furthermore, the digital graphics system 104 generates, stores, modifies, and/or utilizes various typography elements, such as, but not limited to, fonts, typefaces, glyphs, and/or glyph outlines (e.g., curve segments).

Moreover, as described below, the digital typography customization system 106, in one or more embodiments, enables customization of typography elements through electronic free form sketching interactions. For instance, the digital typography customization system 106 utilizes electronic sketch interactions in relation to a visual representation of a glyph to visually customize the glyph while maintaining typography editability properties of the visually modified glyph. In particular, in one or more implementations, the digital typography customization system 106 modifies a visual glyph representation using a sketch outline from an electronic sketch interaction in accordance with one or more implementations herein.

Furthermore, as shown in FIG. 1, the system 100 includes the client device 110. In one or more implementations, the client device 110 includes, but is not limited to, a mobile device (e.g., smartphone, tablet), a laptop, a desktop, or any other type of computing device, including those explained below with reference to FIG. 13. In certain implementations, although not shown in FIG. 1, the client device 110 is operated by a user to perform a variety of functions (e.g., via the digital graphics application 112). For example, the client device 110 performs functions such as, but not limited to, generating, utilizing, and/or modifying typography elements, sketch interactions, and/or digital content items.

To access the functionalities of digital typography customization system 106 (as described above), in one or more implementations, a user interacts with the digital graphics application 112 on the client device 110. For example, the digital graphics application 112 includes one or more software applications installed on the client device 110 (e.g., to customize glyphs via user sketch interactions in accordance with one or more implementations herein). In some cases, the digital graphics application 112 is hosted on the server device(s) 102. In addition, when hosted on the server device(s) 102, the digital graphics application 112 is accessed by the client device 110 through a web browser and/or another online interfacing platform and/or tool.

Although FIG. 1 illustrates the digital typography customization system 106 being implemented by a particular component and/or device within the system 100 (e.g., the server device(s) 102), in some implementations, the digital typography customization system 106 is implemented, in whole or in part, by other computing devices and/or components in the system 100. For example, in some implementations, the digital typography customization system 106 is implemented on the client device 110 within the digital graphics application 112 (e.g., via a client digital typography customization application 114). Indeed, in one or more implementations, the description of (and acts performed by) the digital typography customization system 106 are implemented (or performed by) the client digital typography customization application 114 when the client device 110 implements the digital typography customization system 106. More specifically, in some instances, the client device 110 (via an implementation of the digital typography customization system 106 on the client digital typography customization application 114) enables modification of glyphs via user sketch interactions in accordance with one or more implementations herein.

Additionally, as shown in FIG. 1, the system 100 includes the network 108. As mentioned above, in some instances, the network 108 enables communication between components of the system 100. In certain implementations, the network 108 includes a suitable network and may communicate using any communication platforms and technologies suitable for transporting data and/or communication signals, examples of which are described with reference to FIG. 13. Furthermore, although FIG. 1 illustrates the server device(s) 102 and the client device 110 communicating via the network 108, in certain implementations, the various components of the system 100 communicate and/or interact via other methods (e.g., the server device(s) 102 and the client device 110 communicating directly).

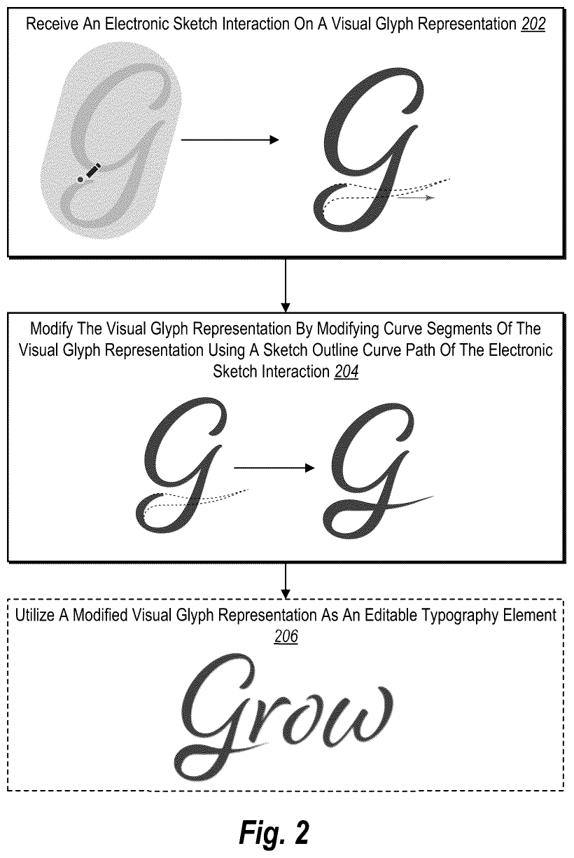

As mentioned above, in one or more implementations, the digital typography customization system 106 customizes a glyph (of a typography element) through electronic (free form) sketching interactions. For instance, FIG. 2 illustrates an overview of an implementation of the digital typography customization system 106 modifying a glyph using an electronic sketch interaction. Indeed, as shown in FIG. 2, the digital typography customization system 106 receives an electronic sketch interaction on a visual glyph representation and modifies the visual glyph representation by modifying curve segments of the visual glyph representation using a sketch outline curve path of the electronic sketch interaction. In some cases, as shown in FIG. 2, the digital typography customization system 106 utilizes the modified visual glyph representation as an editable typography element.

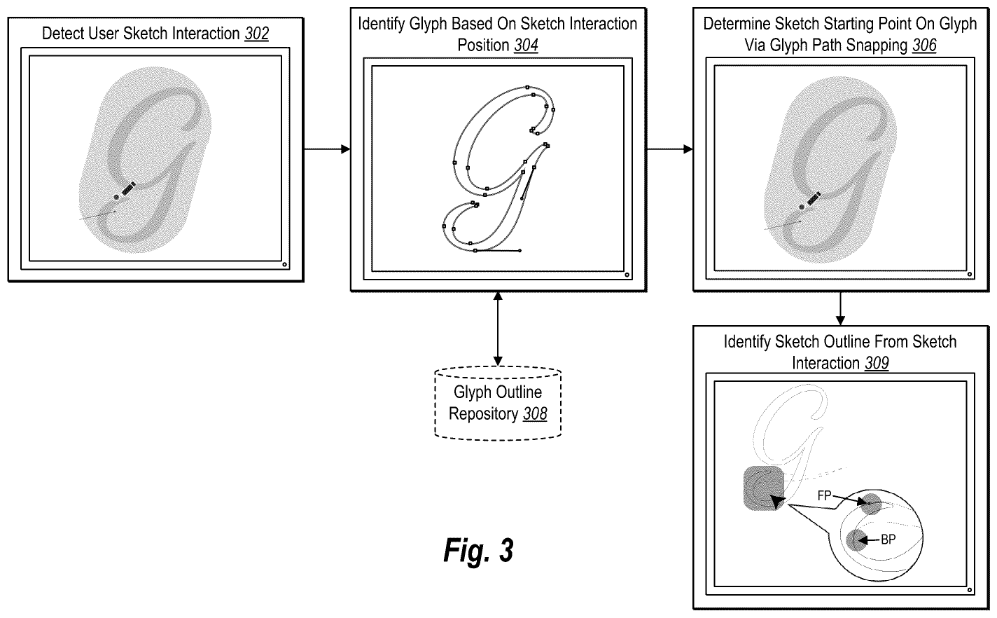

As shown in an act 202 of FIG. 2, the digital typography customization system 106 receives an electronic sketch interaction on a visual glyph representation. For instance, the digital typography customization system 106 identifies a position of the electronic sketch interaction to identify a nearest glyph and utilizes glyph path snapping to determine a starting point of the sketch interaction on one or more curve segments of a glyph outline corresponding to the glyph. Moreover, in one or more instances, the digital typography customization system 106 receives (or determines) a sketch outline from the electronic sketch interaction using a starting point, anchor points of the sketch interaction, and an ending point of the sketch interaction. For instance, the digital typography customization system 106 utilizes an electronic sketch interaction in relation to a visual glyph representation to generate a sketch outline as described below (e.g., in reference to FIG. 3).

In one or more embodiments, a typography element includes information corresponding to a style and/or appearance of one or more characters (e.g., text characters, numerical characters). For instance, a typography element includes glyph, font, and/or text transformation information. For instance, a typography element includes editability properties, such as, but not limited to, font styles (e.g., bold, italicized, underlined), font sizes (e.g., size, kerning, tracking, leading property), font weights, font colors, and/or font effects (e.g., shadows, blur effects, brush effects, glow effects, reflection effects).

Additionally, in one or more cases, a font includes a set of particular styles of a typeface for a collection of characters. In some embodiments, a font includes a combination of a typeface and other stylistic qualities for a collection of characters, such as pitch, spacing, and size. Indeed, in some instances, various types of glyphs (within a single font type) represent a specific character. To provide but one example, a font includes Myriad Pro Regular and a glyph includes, but is not limited to, accented glyphs, Latin glyphs, or Greek glyphs for the font Myriad Pro Regular. In addition, in one or more cases, a character includes a single textual or written element, such as a letter, numeral, or mark of punctuation.

Furthermore, in one or more instances, a visual glyph representation (sometimes referred to as a glyph) includes a specific shape, design, or representation of a character. Indeed, in one or more instances, a visual glyph representation includes a graphical representation of a character or symbol of a font (or typeface). For instance, a visual glyph representation includes digital representations of characters of one or more typography elements (for one or more fonts) that enable rendering a display of a character with a particular visual and functional property corresponding to a typography element and/or a font of a typography element (e.g., design, size, shape, other typography element properties).

In addition, in one or more embodiments, a glyph outline includes a set of points connected by lines and/or curves (e.g., one or more curve segments) to represent a visual contour (or shape) of a glyph. In some instances, a glyph outline includes curve segments represented as Bézier curves that depict or define a contour (or shape) of a glyph. Although one or more embodiments describe the digital typography customization system utilizing one or more curve segments from Bézier curves, in some instances, the digital typography customization system utilizes a variety of curve segments, such as, but not limited to, quadratic Bézier curves, cubic Bézier curves, scalable vector graphic (SVG) paths, and/or spline curves (e.g., B-splines).

Furthermore, in one or more instances, an electronic sketch interaction (sometimes referred to as a sketch interaction) includes a digital interaction through an input device (e.g., stylus, touchscreen, mouse) to create a stroke depicting lines, curves, and/or shapes. For instance, an electronic sketch interaction includes an input via a digital drawing tool that enables the utilization of an input device to create (or generate) drawing lines, curves, and/or shapes within a graphical user interface (or electronic canvas). In some cases, an electronic sketch interaction includes a free form sketch interaction. Indeed, in one or more instances, a free form sketch interaction includes a sketch interaction that facilitates free movement of an input device to fluidly create or generate free form lines, curves, and/or shapes. In some instances, an electronic sketch interaction includes a digital interaction through an input device to create, generate, and/or place shapes (e.g., rectangles, squares, circles, triangles) within a graphical user interface (or electronic canvas).

In one or more instances, the digital typography customization system 106 receives (or detects) electronic sketch interactions (to modify a visual glyph representation) within a variety of digital locations or mediums, such as, but not limited to, within an electronic canvas, within an image, within a text box, within a video. Indeed, in one or more cases, the digital typography customization system 106 utilizes the electronic sketch interaction to modify a visual glyph representation within the variety of digital locations or mediums, such as, but not limited to, within an electronic canvas, within an image, within a text box, within a video.

In some instances, an electronic sketch interaction includes a sketch starting point (e.g., a point at which an input device begins a sketch), one or more anchor points (e.g., one or more intermediate points that define changes in directions of an input device and/or define shape of a sketch interaction), and a sketch ending point (e.g., a point at which an input device ends a sketch). Furthermore, in some instances, the digital typography customization system determines (or generates) a sketch outline from the electronic sketch interaction. Indeed, in one or more embodiments, the sketch outline includes one or more lines connecting (e.g., creating paths) that connect the sketch starting point, the one or more anchor points, and the sketch ending point.

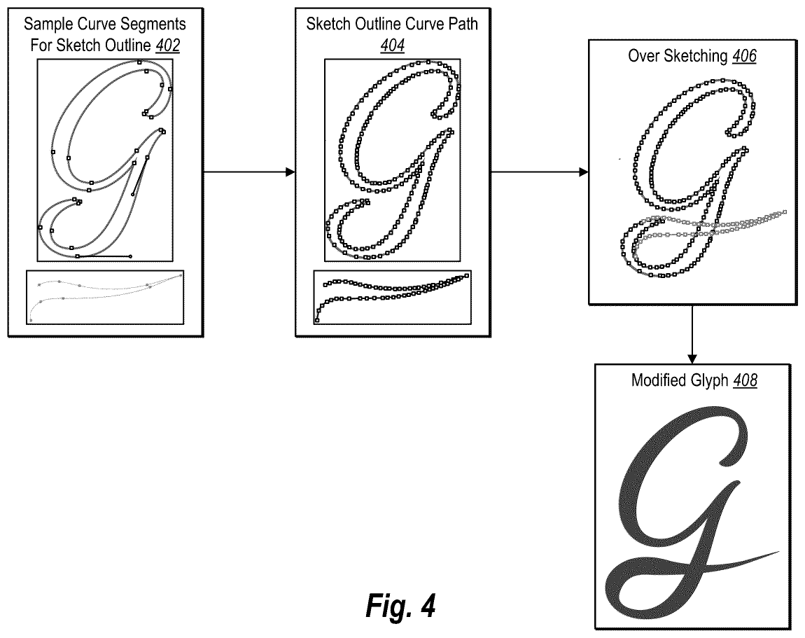

Additionally, as shown in an act 204 of FIG. 2, the digital typography customization system 106 modifies the visual glyph representation by modifying curve segments of the visual glyph representation using a sketch outline curve path of the electronic sketch interaction. In particular, in one or more implementations, the digital typography customization system 106 samples one or more curve segments of the glyph outline for the sketch outline to generate a sketch outline curve path (from the glyph outline curve segments). Moreover, in one or more embodiments, the digital typography customization system 106 modifies the one or more curve segments of the glyph outline by over sketching the sketch outline curve path on the glyph outline curve segments to generate a modified visual glyph representation (e.g., reflecting the user sketch interaction). Indeed, in one or more implementations, the digital typography customization system 106 modifies a visual glyph representation using the sketch outline from an electronic sketch interaction as described below (e.g., in reference to FIG. 4).

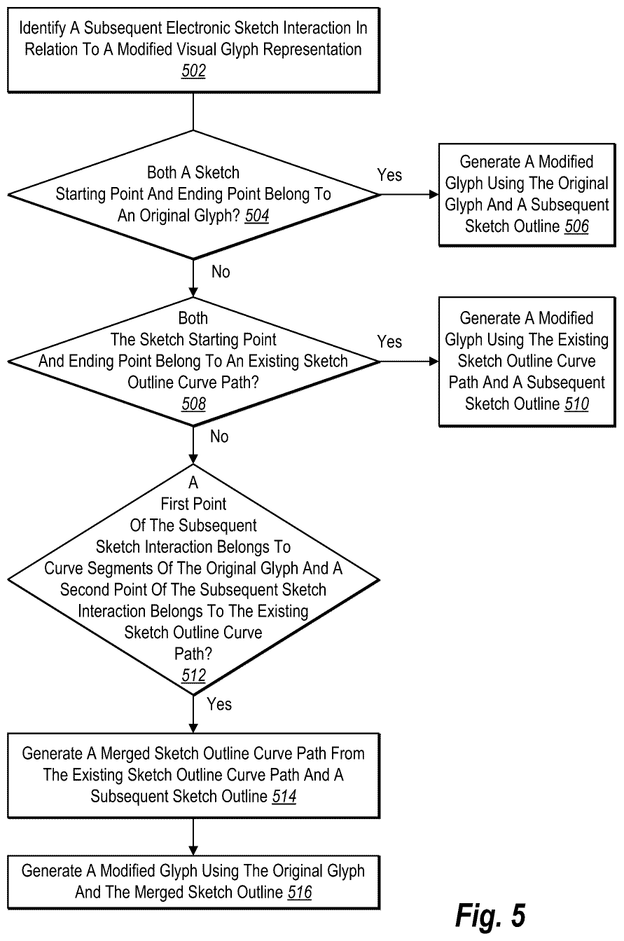

Furthermore, in one or more instances, the digital typography customization system 106 enables re-editing of a modified visual glyph representation. For instance, the digital typography customization system 106 utilizes various combinations of glyph metadata and sketch outline metadata to re-edit a modified visual glyph representation when a subsequent sketch interaction touches the original glyph, touches both the original glyph and the previous sketch outline modifying the original glyph, and/or touches the previous sketch outline modifying the original glyph. For example, the digital typography customization system 106 facilitates re-editing of a modified visual glyph representation utilizing additional electronic sketch interactions as described below (e.g., in reference to FIGS. 5-7).

In one or more instances, the digital typography customization system 106 generates a sketch outline curve path (e.g., by sampling one or more curve segments of a glyph outline). For instance, the sketch outline curve path includes a set of points connected by lines and/or curves (e.g., one or more curve segments) to represent a visual contour (or shape) of the sketch outline utilizing curve segments from a glyph. Indeed, in one or more instances, the sketch outline curve path includes a variety of curve segments, such as, but not limited to, Bézier curves, quadratic Bézier curves, cubic Bézier curves, scalable vector graphic (SVG) paths, and/or spline curves (e.g., B-splines) that depict or define a contour (or shape) of the sketch outline (or sketch interaction).

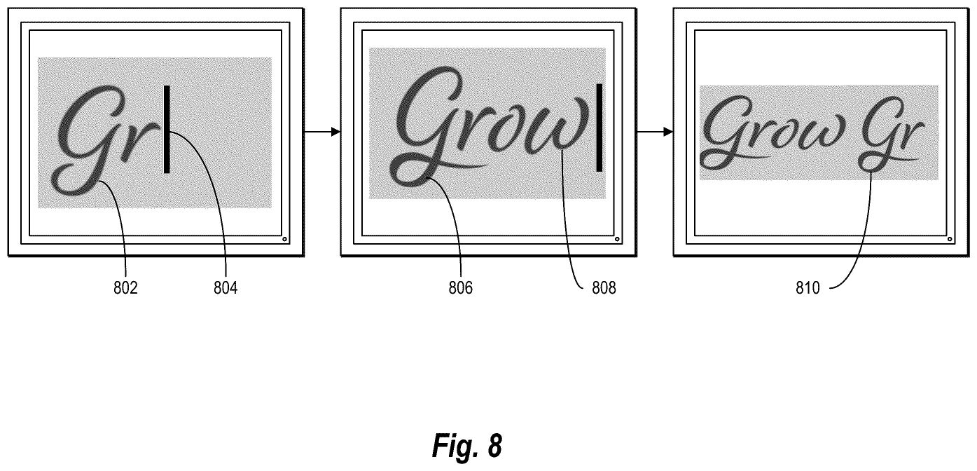

In some embodiments, as shown in an act 206 of FIG. 2, the digital typography customization system 106 also utilizes the visual glyph representation as an editable typography element. For instance, the digital typography customization system 106 enables the utilization of the modified visual glyph representation as a typed element (e.g., a typography element) within a digital content item while maintaining text editability the modified visual glyph representation (as a typography element). Indeed, in one or more instances, the digital typography customization system 106 utilizes a modified visual glyph representation as an editable typography element as described below (e.g., in reference to FIG. 8.

As mentioned above, in one or more instances, the digital typography customization system 106 receives an electronic sketch interaction on a visual glyph representation to generate a sketch outline (for glyph customization). For instance, FIG. 3 illustrates the digital typography customization system 106 receiving an electronic sketch interaction to customize a glyph. In addition, FIG. 3 also illustrates the digital typography customization system 106 determining a sketch outline from the electronic sketch interaction with a visual glyph representation.

As shown in an act 302 of FIG. 3, the digital typography customization system 106 detects a user sketch interaction (within a graphical user interface displaying a visual glyph representation). As further shown in an act 304 of FIG. 3, the digital typography customization system 106 identifies a glyph based on the detected user sketch interaction position (e.g., a nearest visual glyph representation to the user sketch interaction position). For instance, as shown in FIG. 3, in some cases, the digital typography customization system 106 accesses a glyph outline repository 308 to identify a glyph (similar to or matching to the visual glyph representation, within the graphical user interface, identified for the user sketch interaction). In addition, in one or more instances, the digital typography customization system 106 identifies a glyph outline for the glyph (e.g., one or more curve segments for the glyph).

Furthermore, as shown in an act 306 of FIG. 3, the digital typography customization system 106 determines a sketch starting point on the glyph via glyph path snapping. Indeed, in one or more instances, the digital typography customization system 106 determines a sketch starting point utilizing a nearest point on the glyph outline to a user sketch interaction point. Moreover, as shown in an act 309, the digital typography customization system 106 identifies a sketch outline from the sketch interaction with the glyph. Indeed, as shown in FIG. 3, the digital typography customization system 106 determines a starting point, an outline path (e.g., via anchor points), and an ending point of the sketch interaction on the glyph to generate (or identify) a sketch outline from the user sketch interaction.

In one or more instances, the digital typography customization system 106 receives a user sketch interaction and creates an open path (e.g., an open path FF) for the sketch interaction. In addition, the digital typography customization system 106 detects (or identifies), utilizing a current position of the user sketch interaction (e.g., a starting position of the user sketch interaction), a nearest digital object within the graphical user interface. In one or more instances, the digital typography customization system 106 identifies, as the nearest digital object within the graphical user interface, a visual glyph representation (or a digital object representing type text) (e.g., as a glyph G).

In some cases, the digital typography customization system 106 utilizes hit testing between the user sketch interaction (e.g., a starting position of the user sketch interaction) and one or more glyphs (or other digital objects) to determine a nearest glyph with a distance closest to the user sketch interaction starting position. Although one or more implementations describe utilizing hit testing, the digital typography customization system 106, in some cases, utilizes a variety of approaches to identify a glyph (or text object) near a user sketch interaction position (or starting position), such as, but not limited to, bounding box testing. Furthermore, the digital typography customization system 106, in some cases, utilizes hit testing or other glyph identification approaches with various portions of a user sketch interaction (e.g., a starting position, an ending position, an anchor point).

Furthermore, in one or more embodiments, based on detecting a visual glyph representation near a user sketch interaction, the digital typography customization system 106 identifies (or retrieves) a glyph outline for the glyph (e.g., from a glyph outline repository). In some cases, the digital typography customization system 106 identifies a glyph outline that indicates (or includes) one or more curve segments that outline the glyph (e.g., a Bèzier curve, spline curves). In some instances, the digital typography customization system 106 generates the one or more curve segments (e.g., utilizing a Bèzier curve generator, spline curve generator) to generate a glyph outline for the identified glyph.

Additionally, in one or more cases, the digital typography customization system 106 determines a starting point for the user sketch interaction in relation to the identified glyph outline of the visual glyph representation. For example, the digital typography customization system 106 utilizes glyph path snapping with the curve segments of the glyph and the position of the user sketch interaction to identify or detect a curve segment parametric value (e.g., parametric value t) as a point to snap the sketch interaction path starting point. For instance, the digital typography customization system 106 utilizes glyph path snapping to identify a point on one or more of the curve segments of the glyph closes to the user sketch interaction starting position (e.g., the position of a cursor, touch, or electronic stylus pointer).

In some cases, the digital typography customization system 106 identifies a distance between the user sketch interaction and one or more points of the one or more curve segments of the glyph to snap the user sketch interaction position to a point that meets a particular distance threshold (e.g., less than or equal to a particular pixel distance). Moreover, in one or more instances, the digital typography customization system 106 continues to snap updated user sketch interaction positions to one or more points of glyph outline nearest to the updated user sketch interaction positions. In one or more instances, the digital typography customization system 106 utilizes a variety of path snapping approaches, such as, but not limited to, grid-based snapping, proximity detection, magnetic snapping, and/or anchor point snapping. Upon determining a snapping point, the digital typography customization system 106 utilizes the snapping point as a starting point for the user sketch interaction.

Although one or more implementations describe utilizing glyph path snapping, the digital typography customization system 106, in some cases, modifies a glyph by utilizing a user sketch interaction starting position as the starting point of the user sketch interaction.

Furthermore, in one or more embodiments, the digital typography customization system 106 determines a sketch outline from the user sketch interaction that includes a starting point (e.g., FP) of the sketch interaction as a starting position of the sketch (e.g., an electronic pencil down position of the user sketch interaction). In addition, in one or more cases, the digital typography customization system 106 determines anchor points (as intermediate) points of the sketch interaction (to determine a shape of the sketch outline). Moreover, in one or more cases, the digital typography customization system 106 also determines a sketch outline from the user sketch interaction that includes an ending point (e.g., BP) of the sketch interaction as an ending position of the sketch (e.g., an electronic pencil up position of the user sketch interaction). Indeed, in one or more cases, the digital typography customization system 106 utilizes the starting point (e.g., FP), the anchor points, and the ending point (e.g., BP) to generate a sketch outline depicted as a free form sketch path (FF).

As mentioned above, in one or more implementations, the digital typography customization system 106 modifies the visual glyph representation by modifying curve segments of the visual glyph representation using a sketch outline curve path of an electronic sketch interaction. For instance, FIG. 4 illustrates the digital typography customization system 106 modifying a visual glyph representation using a sketch outline. In particular, FIG. 4 illustrates the digital typography customization system 106 modifying a visual glyph representation using path sampling of a glyph outline to generate a sketch outline curve path that is over sketched on the glyph outline to modify the visual glyph representation.

For instance, as shown in an act 402 of FIG. 4, the digital typography customization system 106 samples curve segments from a glyph outline to generate a sketch outline curve path 404 (e.g., joined sampled curve segments from the glyph outline to depict the sketch outline of the user sketch interaction). In addition, as shown in act 406 of FIG. 4, the digital typography customization system 106 over sketches the sketch outline curve path 404 over the glyph outline to generate a modified glyph outline that reflects the user sketch interaction. Indeed, as shown in FIG. 4, the digital typography customization system 106, via the act 406 of over sketching, generates a modified glyph 408 from the modified glyph outline reflecting the user sketch interaction.

In some embodiments, the digital typography customization system 106 samples curve segments from a glyph outline to generate a sketch outline curve path. For instance, the digital typography customization system 106 identifies one or more curve segments F (e.g., a Bézier path) from the glyph outline for the starting point FP of the sketch outline. In addition, in one or more instances, the digital typography customization system 106 also identifies one or more curve segments B (e.g., a Bézier path) from the glyph outline for the ending point BP of the sketch outline. In some cases, the digital typography customization system 106 utilizes a recursive solution to identify a closest distance between curve segments of the glyph outline and the starting point FP and/or the ending point BP of the sketch outline to determine the one or more curve segments F and/or the one or more curve segments B. In some cases, the digital typography customization system 106 utilizes a variety of recursive solutions, such as, but not limited to, base case recursion solutions, merge sort recursion solutions, dynamic programming, backtracking, and/or tail recursion.

Moreover, in one or more cases, the digital typography customization system 106 utilizes the one or more curve segments F and/or the one or more curve segments B to sample a curve path for the sketch outline (e.g., the free form sketch path, FF). In particular, in one or more embodiments, the digital typography customization system 106 samples the one or more curve segments F and/or the one or more curve segments B at particular points and joins the points up with straight lines (e.g., flattening or smoothing) to generate the sketch outline curve path for the sketch outline. In some implementations, the digital typography customization system 106 identifies an X number of segments by sampling the one or more curve segments F and/or the one or more curve segments B at intervals that are spaced based on the X number of segments to generate the generate the sketch outline curve path for the sketch outline.

In addition, in one or more implementations, the digital typography customization system 106 generates the modified visual glyph representation by modifying one or more curve segments of the glyph outline using the sketch outline curve path (from the sketch outline). For instance, the digital typography customization system 106 over sketches the sketch outline curve path onto the one or more curve segments F and/or the one or more curve segments B to replace (or modify) the one or more curve segments F and/or the one or more curve segments B such that the modified glyph outline includes the sketch outline curve path.

In some instances, the digital typography customization system 106 over sketches by utilizing an over sketching tool (or algorithm) that iteratively refines the one or more curve segments F and/or the one or more curve segments B such that the modified glyph outline includes the sketch outline curve path. In particular, in one or more implementations, the digital typography customization system 106 utilizes over sketching to analyze the sketch outline curve path in relation to the one or more curve segments F and/or the one or more curve segments B to determine an intended path and refine the sketch on the glyph outline. For example, the digital typography customization system 106 utilizes over sketching to refine the sketch on the glyph outline by, but not limited to, snapping lines to curves, utilizing smoothening for irregularities, and/or maintaining proportion consistencies. In some implementations, the digital typography customization system 106 utilizes an over sketching approach as described in Baran et. al., Sketching Clothoid Splines Using Shortest Paths, Eurographics Association (2010), Available at http://people.csail.mit.edu/ibaran/papers/2010-EG-Curves.pdf. In some embodiments, the digital typography customization system 106 generates a modified glyph curve path from a sketch outline curve path utilizing a variety of smoothing approaches, such as, but not limited to, G3 curve smoothing, G2 curve smoothing, and/or Kappa curve smoothing.

In addition, in one or more instances, the digital typography customization system 106 generates a modified visual glyph representation from the modified glyph outline. Indeed, in one or more implementations, the digital typography customization system 106 generates a modified visual glyph representation that reflects a modification requested via the user sketch interaction. For instance, the digital typography customization system 106 modifies the visual glyph representation to include, but not limited to, additional art (or content) via the sketch interaction, a deletion (or removal of one or more curve segments) via the sketch interaction, a paint fill via the sketch interaction, and/or an effect via the sketch interaction (e.g., a brush tool, a blur tool, a shadow).

Furthermore, in one or more embodiments, the digital typography customization system 106 generates metadata for the glyph outline and/or metadata for the sketch outline curve path (generated in accordance with one or more implementations herein). In particular, in one or more instances, the digital typography customization system 106 generates the glyph outline metadata and/or the sketch outline curve path metadata to save (or store) the curve segments of the glyph outline and/or sketch outline to enable (or facilitate) re-editing of the modified visual glyph representation. Indeed, in one or more instances, the glyph outline metadata and/or the sketch outline curve path metadata includes curve segment data (e.g., Bézier curve data) and/or path point data for the glyph outline and/or the sketch outline curve path.

As mentioned above, in one or more instances, the digital typography customization system 106 enables re-editing of a modified visual glyph representation. For instance, the digital typography customization system 106 utilizes glyph outline metadata and/or the sketch outline curve path metadata (as described above) to re-edit a modified visual glyph representation from additional electronic sketch interactions. Indeed, in one or more embodiments, the digital typography customization system 106 utilizes various combinations of the glyph metadata and the sketch outline metadata to re-edit a modified visual glyph representation when a subsequent sketch interaction touches the original glyph, touches both the original glyph and the previous sketch outline modifying the original glyph, and/or touches the previous sketch outline modifying the original glyph.

For instance, FIG. 5 illustrates a flow diagram of the digital typography customization system 106 re-editing a modified visual glyph representation from an additional electronic sketch interaction with various combinations of the original glyph and/or the previous sketch outline modifying the original glyph. As shown in an act 502 of FIG. 5, the digital typography customization system 106 identifies a subsequent electronic sketch interaction (within a graphical user interface displaying a modified visual glyph representation). In one or more embodiments, the digital typography customization system 106 determines starting points and ending points of the subsequent electronic sketch interaction using glyph outline metadata and/or sketch outline curve path metadata for a previous sketch outline (e.g., using glyph path snapping) in accordance with one or more implementations herein. Furthermore, in one or more instances, the digital typography customization system 106 utilizes the starting points and ending points of the subsequent electronic sketch interaction to determine whether to utilize the original glyph and/or the previous sketch outline modifying the original glyph to re-edit the modified visual glyph representation.

Furthermore, as shown in a block 504 of FIG. 5, the digital typography customization system 106 determines whether both a sketch starting point and ending point (of the subsequent electronic sketch interaction) belong to (or touch) an original glyph (e.g., one or more curve segments of the glyph outline metadata of an original, unmodified glyph). Upon determining that both the sketch starting point and ending point (of the subsequent electronic sketch interaction) belong to the original glyph, the digital typography customization system 106 (as shown in block 506) generates a modified glyph using the original glyph and a subsequent sketch outline corresponding to the subsequent electronic sketch interaction in accordance with one or more implementations herein. For instance, the digital typography customization system 106 utilizes one or more curve segments from a glyph outline of the original glyph to sample the curve segments of a subsequent sketch outline curve path and over sketches the subsequent sketch outline curve path on the original glyph outline in accordance with one or more implementations herein. Furthermore, the digital typography customization system 106 stores or saves the subsequent sketch outline curve path metadata (as described above).

In one or more instances, the digital typography customization system 106 modifies an original glyph with multiple sketch outline curve paths to generate a modified visual glyph representation that reflects the multiple sketch outline curve paths (while maintaining text editability of the glyph).

In addition, as shown in FIG. 5, the digital typography customization system 106, in some cases, determines that both the sketch starting point and ending point (of the subsequent electronic sketch interaction) do not belong to (or touch) the original glyph (e.g., “no” to the block 504). In response, in one or more embodiments, the digital typography customization system 106 checks other possible variations of the sketch starting point and ending point of the subsequent sketch interaction with the of the glyph metadata and the sketch outline metadata.

For instance, as further shown in a block 508 of FIG. 5, the digital typography customization system 106 determines whether both the sketch starting point and ending point (of the subsequent electronic sketch interaction) belong to (or touch) an existing (or previous) sketch outline curve path (e.g., one or more curve segments of a sketch outline curve path metadata). In some instances, upon determining that both the sketch starting point and ending point (of the subsequent electronic sketch interaction) belong to (or touch) the existing (or previous) sketch outline curve path, the digital typography customization system 106 (as shown in block 510), generates a modified glyph using the existing sketch outline curve path and a subsequent sketch outline.

For example, the digital typography customization system 106 (in reference to block 510) utilizes an existing (or previous) sketch outline curve path as a glyph (e.g., glyph G as described above) and the subsequent sketch outline as the modification (e.g., free form sketch FF as described above). To illustrate, in one or more implementations, the digital typography customization system 106 utilizes one or more curve segments from the existing (or previous) sketch outline curve path to sample the curve segments of a subsequent sketch outline curve path and over sketches the subsequent sketch outline curve path on the existing (or previous) sketch outline curve path in accordance with one or more implementations herein. Moreover, in some instances, the digital typography customization system 106 modifies the visual glyph representation utilizing the modified sketch outline curve path (that reflects both the existing sketch outline and a subsequent sketch outline) in accordance with one or more implementations.

Furthermore, the digital typography customization system 106 stores or saves the modified sketch outline curve path metadata (as described above). In addition, in one or more instances, the digital typography customization system 106 modifies one or more previous (or existing) sketch outline curve paths (of a modified glyph) with various numbers of subsequent sketch outline curve paths to generate a re-edited modified visual glyph representation that reflects the multiple sketch outline curve paths (while maintaining text editability of the glyph).

In addition, as shown in FIG. 5, the digital typography customization system 106, in some cases, determines that both the sketch starting point and ending point (of the subsequent electronic sketch interaction) do not belong to (or touch) the existing (or previous) sketch outline curve path (e.g., “no” to the block 508). In response, in one or more embodiments, the digital typography customization system 106 checks (or utilizes) other possible variations of the sketch starting point and ending point of the subsequent sketch interaction with the of the glyph metadata and the sketch outline metadata.

For example, as shown in block 512, the digital typography customization system 106 determines whether a first point of the subsequent sketch interaction belongs to (or touches) one or more curve segments of the original glyph and a second point of the subsequent sketch interaction belongs to the existing (or previous) sketch outline curve path. Indeed, in one or more cases, the first point and the second point of the subsequent sketch interaction includes the sketch starting point and/or the sketch ending point interchangeably.

In one or more instances, as shown in an act 514 of FIG. 5, upon determining that the first point of the subsequent sketch interaction belongs (or touches) the one or more curve segments of the original glyph and the second point of the subsequent sketch interaction belongs to the existing (or previous) sketch outline curve path, the digital typography customization system 106 generates a merged sketch outline curve path from the existing (or previous) sketch outline curve path and a subsequent sketch outline. Furthermore, as shown in an act 516 of FIG. 5, the digital typography customization system 106 generates a modified glyph using the original glyph and the merged sketch outline (in accordance with one or more implementations herein).

Although FIG. 5 illustrates a specific order for checking touchpoints of a sketch interaction to re-edit a modified visual glyph representation utilizing a particular combination of the glyph metadata and the sketch outline metadata to re-edit a modified visual glyph representation when a subsequent sketch interaction touches the original glyph, touches both the original glyph and the previous sketch outline modifying the original glyph, and/or touches the previous sketch outline modifying the original glyph, the digital typography customization system 106, in one or more instances, utilizes various orders of checking touchpoints of a sketch interaction to re-edit a modified visual glyph representation.

To illustrate, in one or more embodiments, if a curve segment F (new) that touches the subsequent sketch interaction belongs to the original glyph, the digital typography customization system 106 utilizes a sketch starting point FP (new) of the subsequent sketch interaction and a sketch ending point BP (original) of the existing (or previous) sketch outline curve path to generate a merged sketch outline. For instance, the digital typography customization system 106 performs over sketching (in accordance with one or more implementations herein) between the existing (or previous) sketch outline (e.g., FF (original)) and a subsequent sketch outline (e.g., FF (new)) to generate a merged sketch outline (e.g., FF (merged)).

Furthermore, in one or more instances, the digital typography customization system 106 utilizes the merged sketch outline FF (merged) to identify one or more curve segments F (merged) for the sketch starting point FP (new) and one or more curve segments B (merged) for the sketch starting point BP (original) (in accordance with one or more implementations herein). In addition, in one or more instances, the digital typography customization system 106 utilizes the one or more curve segments F (merged) and/or the one or more curve segments B (merged) to sample a curve path for the merged sketch outline FF (merged) as a merged sketch outline curve path (in accordance with one or more implementations). Moreover, in one or more implementations, the digital typography customization system 106 over sketches the merged sketch outline curve path onto the one or more curve segments F (merged) and/or the one or more curve segments B (merged) of the glyph outline to replace (or modify) the one or more curve segments F (merged) and/or the one or more curve segments B (merged) such that the modified glyph outline includes the merged sketch outline curve path (in accordance with one or more implementations). Indeed, in one or more instances, the digital typography customization system 106 utilizes the modified glyph outline to generate a modified visual glyph representation that reflects a modification requested via previous user sketch interaction and the subsequent user sketch interaction (e.g., via the merged sketch outline).

Although one or more embodiments describes merging sketch outlines when the curve segment F (new) that touches the subsequent sketch interaction belongs to the original glyph, the digital typography customization system 106, in one or more instances, generates a modified visual glyph representation when the curve segment F (new) that touches the subsequent sketch interaction belongs to an existing (or previous) sketch outline curve path. In some implementations, the digital typography customization system 106 utilizes a sketch ending point BP (new) of the subsequent sketch interaction and a sketch starting point FP (original) of the existing (or previous) sketch outline curve path to generate a merged sketch outline FF (merged) for the glyph modification as described above. In addition, in one or more embodiments, the digital typography customization system 106 merges various numbers of sketch interactions to create a merged sketch outline FF (merged) for a glyph modification in accordance with one or more implementations herein.

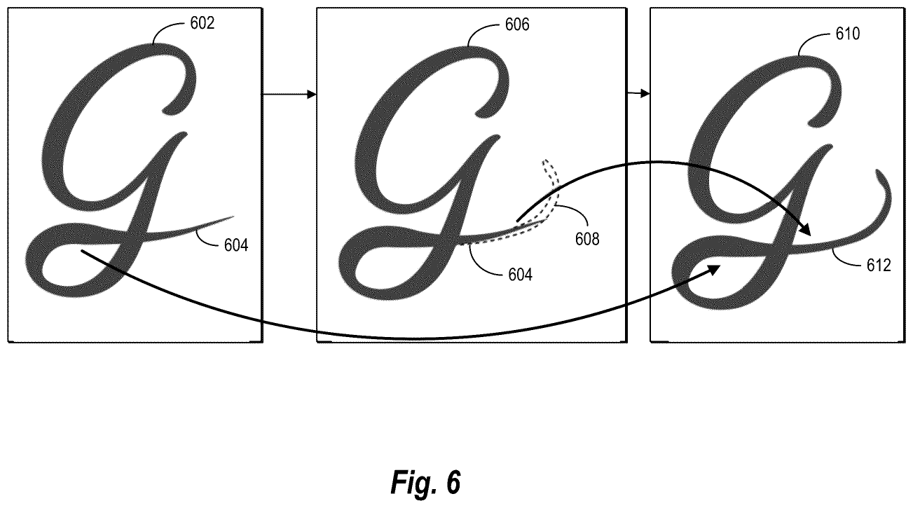

As an example, FIG. 6 illustrates the digital typography customization system 106 re-editing a modified visual glyph representation when a sketch starting point and a sketch ending point of an additional sketch interaction belong to an existing sketch outline curve path. For instance, as shown in FIG. 6, the digital typography customization system 106 displays, within a graphical user interface, a modified visual glyph representation 602 having an existing sketch modification 604. Moreover, as shown in FIG. 6, the digital typography customization system 106 receives an additional user sketch interaction 608 that touches the existing sketch modification 604 on a modified visual glyph representation 606. Indeed, as further shown in FIG. 6, the digital typography customization system 106 utilizes the additional user sketch interaction 608 to generate a re-edited visual glyph representation 610 with a new sketch modification 612 utilizing the existing sketch modification 604 and a sketch outline of the additional user sketch interaction 608 (in accordance with one or more implementations herein).

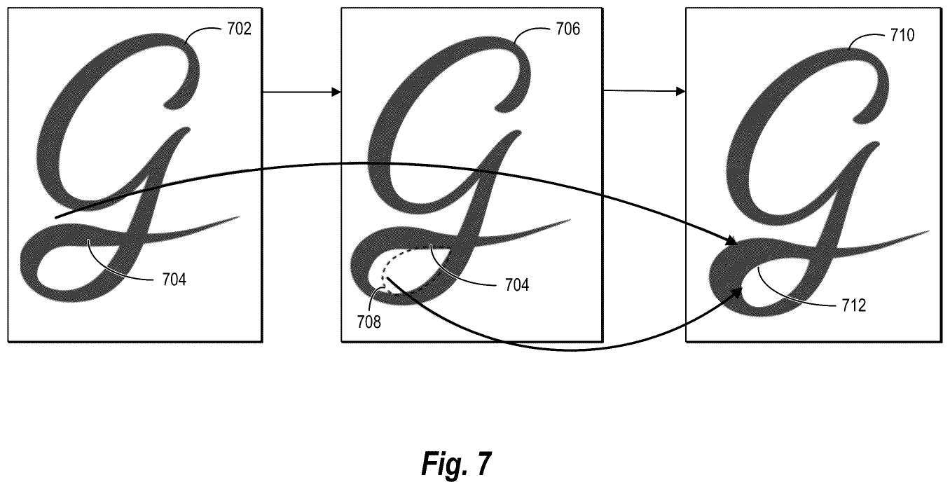

Additionally, FIG. 7 illustrates the digital typography customization system 106 re-editing a modified visual glyph representation when a first point of an additional sketch interaction belongs to one or more curve segments of the original glyph and a second point of the additional sketch interaction belongs to an existing (or previous) sketch outline curve path. For instance, as shown in FIG. 7, the digital typography customization system 106 displays, within a graphical user interface, a modified visual glyph representation 702 having an existing sketch modification 704. Furthermore, as shown in FIG. 7, the digital typography customization system 106 receives an additional user sketch interaction 708 that includes a first point that belongs to one or more curve segments of an original glyph corresponding to a modified visual glyph representation 706 and a second point that belongs to the existing sketch modification 704. Indeed, as shown in FIG. 7, the digital typography customization system 106 utilizes the additional user sketch interaction 708 to generate a re-edited visual glyph representation 710 with a new sketch modification 712 utilizing a merged sketch outline generated from between the additional user sketch interaction 708 and the existing sketch modification 704 (in accordance with one or more implementations herein).

As mentioned above, in one or more instances, the digital typography customization system 106 enables the utilization of the modified visual glyph representation as a typed element (e.g., a typography element) within a digital content item (that maintains text editability). For instance, FIG. 8 illustrates the digital typography customization system 106 enabling the utilization of a modified visual glyph representation as a typography element. For example, as shown in FIG. 8, the digital typography customization system 106 displays a visual glyph representation 802, within a graphical user interface of a client device, as a typography element as part of a text input application capable of text input 804. Furthermore, as shown in FIG. 8, the digital typography customization system 106 modifies the visual glyph representation 802 utilizing a user sketch interaction to generate a modified visual glyph representation 806 (in accordance with one or more implementations herein).

Moreover, as shown in FIG. 8, the digital typography customization system 106 continues to receive text input 808 in relation to the modified visual glyph representation 806. Furthermore, as illustrated in FIG. 8, the digital typography customization system 106 utilizes, as an additional typography (text) input, an additional visual glyph representation 810 having the user sketch interaction modifications (from the modified visual glyph representation 806).

Indeed, in one or more instances, the digital typography customization system 106 utilizes a modified visual glyph representation as a typography element with typographic modification properties intact (e.g., font style adjustments, font size adjustments, font weight adjustments, font color adjustments, font effect adjustments). For instance, the digital typography customization system 106 enables typing of the modified visual glyph representation and/or additional sketch-based modification of the modified visual glyph representation. In addition, in one or more embodiments, the modified visual glyph representation receives typographic modification property adjustments that include, but are not limited to, bolding the modified visual glyph representation, italicizing the modified visual glyph representation, increasing and/or decreasing the size of the modified visual glyph representation, and/or changing a kerning, tracking, and/or leading property of the modified visual glyph representation. Furthermore, in one or more instances, the digital typography customization system 106 utilizes the typography elements based on the modified visual glyph representation in various text recognition tasks.

Although one or more embodiments describe in-memory customization of glyph representations, in some cases, the digital typography customization system 106 utilizes sketch interactions with one or more visual glyph representations to generate a font style (or library of stylized or customized typography elements). For instance, the digital typography customization system 106 modifies an existing set of glyphs using user sketch interactions and saves the modified glyphs as a customized font. Indeed, in one or more instances, the digital typography customization system 106 enables the utilization of the customized font as a typography element in various digital content items.

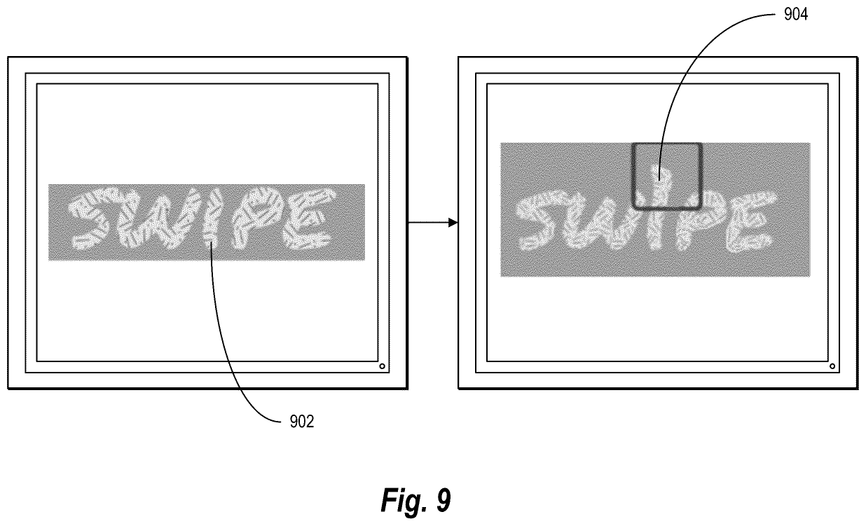

Moreover, FIG. 9 illustrates an example of a visual glyph representation modified using a user sketch interaction with an implementation of the digital typography customization system 106. For instance, as shown in FIG. 9, the digital typography customization system 106 modifies a visual glyph representation 902 to generate a modified visual glyph representation 904 from a user sketch interaction (in accordance with one or more implementations herein) that expands the top portion of the visual glyph representation 902. In addition, as shown in FIG. 9, the digital typography customization system 106 also paint fills the texture within the modified visual glyph representation 904 for the newly added portion of the modified visual glyph representation 904 via a pencil tool sketch interaction.

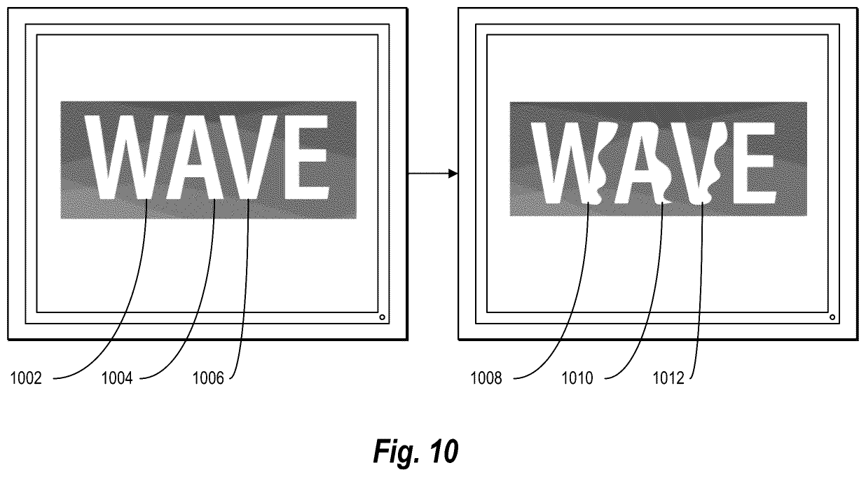

Furthermore, FIG. 10 also illustrates an example of a visual glyph representation modified using a user sketch interaction with an implementation of the digital typography customization system 106. For example, as shown in FIG. 10, the digital typography customization system 106 modifies a visual glyph representation 1002, visual glyph representation 1004, and visual glyph representation 1006 to generate a modified visual glyph representation 1008, modified visual glyph representation 1010, and modified visual glyph representation 1012 from user sketch interactions with the visual glyph representation 1002, the visual glyph representation 1004, and the visual glyph representation 1006 (in accordance with one or more implementations herein). Indeed, as shown in FIG. 10, the digital typography customization system 106 receives user sketch interactions with a variety of visual glyph representations to modify (or customize) the visual glyph representations.

Although one or more embodiments illustrate utilizing a user sketch interaction to add a visual element to a modified visual glyph representation, the digital typography customization system 106, in one or more embodiments, receives user sketch interactions to modify a glyph via a variety of properties, such as, but not limited to, erasure, paint filling, blurring, and/or adding a fill object (e.g., an image or generative machine learning fill object) that adds an adornment object (e.g., an image or other graphical object) within the sketched fill object space.

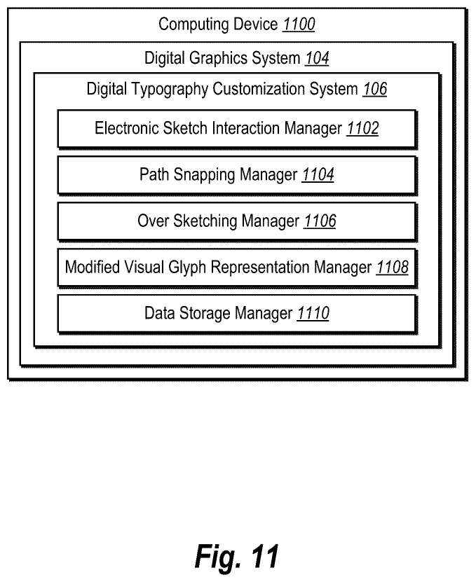

Turning now to FIG. 11, additional detail will be provided regarding components and capabilities of one or more embodiments of the digital typography customization system. In particular, FIG. 11 illustrates an example digital typography customization system 106 executed by a computing device 1100 (e.g., the server device(s) 102 and/or the client device 110). As shown by the embodiment of FIG. 11, the computing device 1100 includes or hosts the digital graphics system 104 and the digital typography customization system 106. Furthermore, as shown in FIG. 11, the digital graphics system 104 includes an electronic sketch interaction manager 1102, a path snapping manager 1104, an over sketching manager 1106, a modified visual glyph representation manager 1108, and data storage manager 1110.

As just mentioned, and as illustrated in the embodiment of FIG. 11, the digital typography customization system 106 includes the electronic sketch interaction manager 1102. For example, the electronic sketch interaction manager 1102 receives one or more electronic user sketch interactions as described above (e.g., in reference to FIGS. 2 and 3). In some cases, the electronic sketch interaction manager 1102 receives (or detects) electronic sketch interactions for drawing tools that modify a visual glyph representation as described above (e.g., in reference to FIGS. 2 and 3).

Moreover, as shown in FIG. 11, the digital typography customization system 106 includes the path snapping manager 1104. In some cases, the path snapping manager 1104 identifies a glyph outline in relation to a user electronic sketch interaction as described above (e.g., in reference to FIGS. 2 and 3). Moreover, in one or more embodiments, the path snapping manager 1104 utilizes a glyph outline with a user electronic sketch interaction with glyph path snapping to determine a sketch starting point on the glyph outline as described above (e.g., in reference to FIGS. 2, 3, and 5-7).

Furthermore, as shown in FIG. 11, the digital typography customization system 106 includes the over sketching manager 1106. In some embodiments, the over sketching manager 1106 samples a glyph outline to generate a sketch outline curve path from a sketch outline of a sketch interaction as described above (e.g., in reference to FIGS. 4-7). In certain instances, the over sketching manager 1106 also over sketches the sketch outline curve path onto one or more curve segments of the glyph outline to generate a modified visual glyph representation as described above (e.g., in reference to FIGS. 4-7).

Furthermore, as shown in FIG. 11, the digital typography customization system 106 includes the modified visual glyph representation manager 1108. In some embodiments, the modified visual glyph representation manager 1108 stores and/or manages sketch outline metadata for modified visual glyph representations for re-editing as described above (e.g., in reference to FIGS. 5-7). In some embodiments, the modified visual glyph representation manager 1108 also facilitates the utilization of the modified visual glyph representations as typography elements (with text editability) as described above (e.g., in reference to FIGS. 8-10).

As further shown in FIG. 11, the digital typography customization system 106 includes the data storage manager 1110. In some embodiments, the data storage manager 1110 maintains data to perform one or more functions of the digital typography customization system 106. For example, the data storage manager 1110 includes, but is not limited to, glyphs, glyph outlines, glyph outline metadata, sketch interaction outlines, sketch curve path metadata, typography elements, digital drawing tools, and/or smoothing or over sketching tools.

Each of the components 1102-1110 of the computing device 1100 (e.g., the computing device 1100 implementing the digital typography customization system 106), as shown in FIG. 11, may be in communication with one another using any suitable technology. The components 1102-1110 of the computing device 1100 can comprise software, hardware, or both. For example, the components 1102-1110 can comprise one or more instructions stored on a computer-readable storage medium and executable by processor of one or more computing devices. When executed by the one or more processors, the computer-executable instructions of the digital typography customization system 106 (e.g., via the computing device 1100) can cause a client device and/or server device to perform the methods described herein. Alternatively, the components 1102-1110 and their corresponding elements can comprise hardware, such as a special purpose processing device to perform a certain function or group of functions. Additionally, the components 1102-1110 can comprise a combination of computer-executable instructions and hardware.

Furthermore, the components 1102-1110 of the digital typography customization system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1102-1110 may be implemented as a stand-alone application, such as a desktop or mobile application. Furthermore, the components 1102-1110 may be implemented as one or more web-based applications hosted on a remote server. The components 1102-1110 may also be implemented in a suite of mobile device applications or “apps.” To illustrate, the components 1102-1110 may be implemented in an application, including but not limited to, ADOBE PHOTOSHOP, ADOBE PREMIERE, ADOBE LIGHTROOM, ADOBE ILLUSTRATOR, ADOBE READER, ADOBE PRINT, OR ADOBE SENSEI. “ADOBE,” “ADOBE PHOTOSHOP,” “ADOBE PREMIERE,” “ADOBE LIGHTROOM,” “ADOBE ILLUSTRATOR,” “ADOBE READER,” “ADOBE PRINT,” or “ADOBE SENSEI” are either registered trademarks or trademarks of Adobe Inc. in the United States and/or other countries.

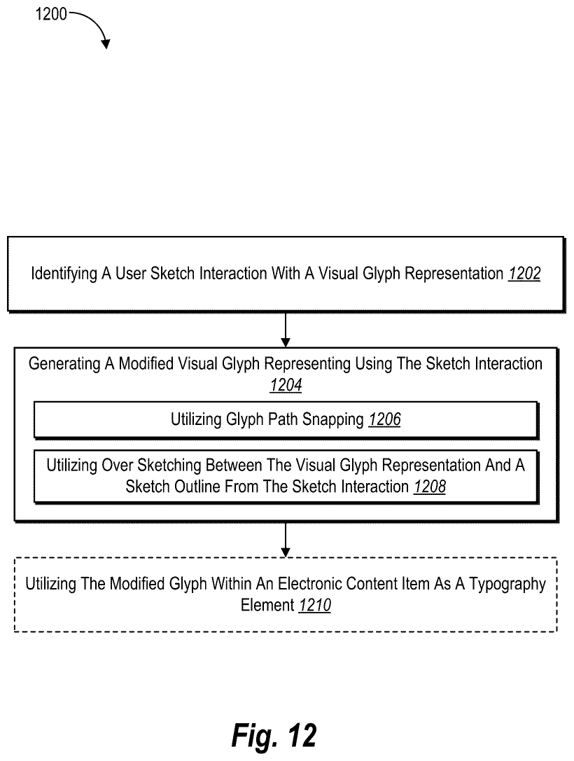

FIGS. 1-11, the corresponding text, and the examples provide a number of different methods, systems, devices, and non-transitory computer-readable media of the digital typography customization system 106. In addition to the foregoing, one or more embodiments can also be described in terms of flowcharts comprising acts for accomplishing a particular result, as shown in FIG. 12. The acts shown in FIG. 12 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 12. In some embodiments, a system can be configured to perform the acts of FIG. 12. Alternatively, the acts of FIG. 12 can be performed as part of a computer implemented method.

As mentioned above, FIG. 12 illustrates a flowchart of a series of acts 1200 for customizing typography elements through electronic sketching interactions in accordance with one or more implementations. While FIG. 12 illustrates acts according to one embodiment, alternative embodiments may omit, add to, reorder, and/or modify any of the acts shown in FIG. 12.

As shown in FIG. 12, the series of acts 1200 include an act 1202 of identifying a user sketch interaction with a visual glyph representation. In some cases, the act 1202 includes identifying, via a user interaction within a graphical user interface, an electronic sketch interaction on the visual glyph representation. In one or more instances, the act 1202 includes identifying, via a user interaction within a graphical user interface, an electronic free form sketch interaction in relation to a visual glyph representation of a typography element.

Furthermore, as shown in FIG. 12, the series of acts 1200 include an act 1204 of generating a modified visual glyph representation using the sketch interaction. In one or more embodiments, the act 1204 includes generating a modified visual glyph representation by modifying one or more curve segments of the visual glyph representation utilizing a sketch outline curve path corresponding to the electronic sketch interaction. In some instances, the act 1204 includes generating a modified visual glyph representation by modifying the visual glyph representation using the electronic free form sketch interaction.

Furthermore, in some instances, the act 1204 includes an act 1206 of utilizing glyph path snapping. For example, the act 1206 includes identifying, via an electronic sketch interaction within a graphical user interface, a sketch outline in relation to a visual glyph representation utilizing glyph path snapping. Additionally, in some embodiments, the act 1204 includes an act 1208 of utilizing over sketching between the visual glyph representation and a sketch outline from the sketch interaction. In particular, in some cases, the act 1208 includes generating a modified visual glyph representation by sampling one or more curve segments from the visual glyph representation for the sketch outline to generate a sketch outline curve path. Furthermore, in some instances, the act 1208 includes generating a modified visual glyph representation by modifying the one or more curve segments of the visual glyph representation utilizing the sketch outline curve path.

In some cases, as shown in FIG. 12, the series of acts 1200 include an act 1210 of utilizing the modified glyph within an electronic content item as a typography element. For instance, the act 1210 includes utilizing a modified visual glyph representation as an (additional editable typography element). In addition, in some cases, the act 1210 includes, based on a typography user interaction, utilizing, within an electronic content item, an editable typography element corresponding to the modified visual glyph representation.

In some embodiments, the series of acts 1200 include utilizing an additional editable typography element within an electronic content item as a text element that enables one or more typographic modifications. For example, the one or more typographic modifications includes a font weight adjustment, a font style adjustment, a font size adjustment, a font color adjustment, and/or a font effect adjustment. For instance, an editable typography element facilitates one or more of a font weight adjustment, a font style adjustment, a font size adjustment, a font color adjustment, and/or a font effect adjustment. In some cases, the series of acts 1200 include utilizing the modified visual glyph representation as an editable typography element that enables one or more typographic modifications. In addition, in one or more embodiments, the series of acts 1200 include, based on a typography user interaction, utilizing, within an electronic content item, the editable typography element corresponding to the modified visual glyph representation.

Furthermore, in some cases, the series of acts 1200 include utilizing glyph path snapping to identify a sketch outline of the electronic sketch interaction in relation to the visual glyph representation.

In addition, in some instances, the series of acts 1200 include generating the sketch outline curve path by sampling the one or more curve segments from the visual glyph representation in reference to a sketch outline of the electronic sketch interaction. In some embodiments, the series of acts 1200 include modifying the one or more curve segments of the visual glyph representation by over sketching the sketch outline curve path on the one or more curve segments of the visual glyph representation. In some instances, the series of acts 1200 include generating the modified visual glyph representation by adding a new curve segment to the visual glyph representation or removing a curve segment from the one or more curve segments of the visual glyph representation.

In some cases, the series of acts 1200 include generating the modified visual glyph representation by modifying one or more curve segments of the visual glyph representation by over sketching a sketch outline curve path corresponding to the electronic free form sketch interaction on the one or more curve segments of the visual glyph representation. Moreover, in some cases, the series of acts 1200 include generating the modified visual glyph representation by adding a new curve segment to the visual glyph representation to depict an adornment to the visual glyph representation. In some instances, the series of acts 1200 include generating the modified visual glyph representation by adding a new curve segment to the visual glyph representation or removing a curve segment from the one or more curve segments of the visual glyph representation.

Additionally, in some cases, the series of acts 1200 include generating an additional modified visual glyph representation based on identifying, via an additional user interaction within the graphical user interface, a subsequent electronic sketch interaction on the modified visual glyph representation. Moreover, in some embodiments, the series of acts 1200 include, based on identifying that a starting point and an ending point of the subsequent electronic sketch interaction belong to the sketch outline curve path corresponding to the electronic sketch interaction, generating the additional modified visual glyph representation using the sketch outline curve path corresponding to the electronic sketch interaction. Furthermore, in one or more instances, the series of acts 1200 include, based on identifying that a first point of the subsequent electronic sketch interaction belongs to the one or more curve segments of the visual glyph representation and a second point of the subsequent electronic sketch interaction belongs to the sketch outline curve path corresponding to the electronic sketch interaction, generating the additional modified visual glyph representation using the one or more curve segments of the visual glyph representation and a merged sketch outline curve path corresponding to the sketch outline curve path corresponding to the electronic sketch interaction and an additional sketch outline curve path corresponding to the subsequent electronic sketch interaction. In some cases, the series of acts 1200 include, based on identifying that a starting point and an ending point of the subsequent electronic sketch interaction belongs to the one or more curve segments of the visual glyph representation, generating the additional modified visual glyph representation using the one or more curve segments of the visual glyph representation.

In one or more embodiments, the series of acts 1200 include generating an additional modified visual glyph representation based on identifying, via an additional user interaction within the graphical user interface, a subsequent electronic free form sketch interaction on the modified visual glyph representation based on metadata corresponding to one or more curve segments of the visual glyph representation or additional metadata corresponding to a sketch outline curve path of the electronic free form sketch interaction. In addition, in one or more instances, the series of acts 1200 include, based on identifying a subsequent electronic sketch interaction within the graphical user interface on the modified visual glyph representation, generating an additional modified visual glyph representation using the sketch outline curve path corresponding to the electronic sketch interaction.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A network is one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., the server device(s) 102 and/or the client device 110). In one or more implementations, the computing device 1300 may be a mobile device (e.g., a mobile telephone, a smartphone, a PDA, a tablet, a laptop, a camera, a tracker, a watch, a wearable device, etc.). In some implementations, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other implementations. Furthermore, in certain implementations, the computing device 1300 includes fewer components than those shown in FIG. 13. Components of the computing device 1300 shown in FIG. 13 will now be described in additional detail.

In particular implementations, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, the storage device 1306 can include a non-transitory storage medium described above. The storage device 1306 may include a hard disk drive (“HDD”), flash memory, a Universal Serial Bus (“USB”) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (“NIC”) or network adapter for communicating with an Ethernet or other wire-based network or a wireless NIC (“WNIC”) or wireless adapter for communicating with a wireless network, such as a WI-FI. The computing device 1300 can further include a bus 1312. The bus 1312 can include hardware, software, or both that connects components of the computing device 1300 to each other.

In the foregoing specification, the invention has been described with reference to specific example implementations thereof. Various implementations and aspects of the invention(s) are described with reference to details discussed herein, and the accompanying drawings illustrate the various implementations. The description above and drawings are illustrative of the invention and are not to be construed as limiting the invention. Numerous specific details are described to provide a thorough understanding of various implementations of the present invention.

The present invention may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
a memory component comprising a visual glyph representation of an editable typography element; and
a processing device coupled to the memory component, the processing device to perform operations comprising:
identifying, via a user interaction within a graphical user interface, an electronic sketch interaction on the visual glyph representation;
generating a modified visual glyph representation by modifying one or more curve segments of the visual glyph representation utilizing a sketch outline curve path corresponding to the electronic sketch interaction; and
utilizing the modified visual glyph representation as an additional editable typography element.

2. The system of claim 1, wherein the operations further comprise utilizing the additional editable typography element within an electronic content item as a text element that enables one or more typographic modifications, wherein the one or more typographic modifications comprise a font weight adjustment, a font style adjustment, a font size adjustment, a font color adjustment, or a font effect adjustment.

3. The system of claim 1, wherein the operations further comprise utilizing glyph path snapping to identify a sketch outline of the electronic sketch interaction in relation to the visual glyph representation.

4. The system of claim 1, wherein the operations further comprise generating the sketch outline curve path by sampling the one or more curve segments from the visual glyph representation in reference to a sketch outline of the electronic sketch interaction.

5. The system of claim 4, wherein the operations further comprise modifying the one or more curve segments of the visual glyph representation by over sketching the sketch outline curve path on the one or more curve segments of the visual glyph representation.

6. The system of claim 1, wherein the operations further comprise generating an additional modified visual glyph representation based on identifying, via an additional user interaction within the graphical user interface, a subsequent electronic sketch interaction on the modified visual glyph representation.

7. The system of claim 6, wherein the operations further comprise, based on identifying that a starting point and an ending point of the subsequent electronic sketch interaction belong to the sketch outline curve path corresponding to the electronic sketch interaction, generating the additional modified visual glyph representation using the sketch outline curve path corresponding to the electronic sketch interaction.

8. The system of claim 6, wherein the operations further comprise, based on identifying that a first point of the subsequent electronic sketch interaction belongs to the one or more curve segments of the visual glyph representation and a second point of the subsequent electronic sketch interaction belongs to the sketch outline curve path corresponding to the electronic sketch interaction, generating the additional modified visual glyph representation using the one or more curve segments of the visual glyph representation and a merged sketch outline curve path corresponding to the sketch outline curve path corresponding to the electronic sketch interaction and an additional sketch outline curve path corresponding to the subsequent electronic sketch interaction.

9. The system of claim 6, wherein the operations further comprise, based on identifying that a starting point and an ending point of the subsequent electronic sketch interaction belongs to the one or more curve segments of the visual glyph representation, generating the additional modified visual glyph representation using the one or more curve segments of the visual glyph representation.

10. The system of claim 1, wherein the operations further comprise generating the modified visual glyph representation by adding a new curve segment to the visual glyph representation or removing a curve segment from the one or more curve segments of the visual glyph representation.

11. A computer-implemented method comprising:
identifying, via a user interaction within a graphical user interface, an electronic free form sketch interaction in relation to a visual glyph representation of a typography element;
generating a modified visual glyph representation by modifying the visual glyph representation using the electronic free form sketch interaction; and
based on a typography user interaction, utilizing, within an electronic content item, an editable typography element corresponding to the modified visual glyph representation.

12. The computer-implemented method of claim 11, wherein the editable typography element facilitates one or more of a font weight adjustment, a font style adjustment, a font size adjustment, a font color adjustment, or a font effect adjustment.

13. The computer-implemented method of claim 11, further comprising generating the modified visual glyph representation by modifying one or more curve segments of the visual glyph representation by over sketching a sketch outline curve path corresponding to the electronic free form sketch interaction on the one or more curve segments of the visual glyph representation.

14. The computer-implemented method of claim 11, further comprising generating an additional modified visual glyph representation based on identifying, via an additional user interaction within the graphical user interface, a subsequent electronic free form sketch interaction on the modified visual glyph representation based on metadata corresponding to one or more curve segments of the visual glyph representation or additional metadata corresponding to a sketch outline curve path of the electronic free form sketch interaction.

15. The computer-implemented method of claim 11, further comprising generating the modified visual glyph representation by adding a new curve segment to the visual glyph representation to depict an adornment to the visual glyph representation.

16. A non-transitory computer-readable medium storing instructions that, when executed by at least one processor, cause the at least one processor to perform operations comprising:
identifying, via an electronic sketch interaction within a graphical user interface, a sketch outline in relation to a visual glyph representation utilizing glyph path snapping; and
generating a modified visual glyph representation by:
sampling one or more curve segments from the visual glyph representation for the sketch outline to generate a sketch outline curve path; and
modifying the one or more curve segments of the visual glyph representation utilizing the sketch outline curve path.

17. The non-transitory computer-readable medium of claim 16, wherein the operations further comprise utilizing the modified visual glyph representation as an editable typography element that enables one or more typographic modifications, wherein the one or more typographic modifications comprise a font weight adjustment, a font style adjustment, a font size adjustment, a font color adjustment, or a font effect adjustment.

18. The non-transitory computer-readable medium of claim 17, wherein the operations further comprise, based on a typography user interaction, utilizing, within an electronic content item, the editable typography element corresponding to the modified visual glyph representation.

19. The non-transitory computer-readable medium of claim 16, wherein the operations further comprise, based on identifying a subsequent electronic sketch interaction within the graphical user interface on the modified visual glyph representation, generating an additional modified visual glyph representation using the sketch outline curve path corresponding to the electronic sketch interaction.

20. The non-transitory computer-readable medium of claim 16, wherein the operations further comprise generating the modified visual glyph representation by adding a new curve segment to the visual glyph representation or removing a curve segment from the one or more curve segments of the visual glyph representation.
